(19) United States
(12) Patent Application Publication
(10) Pub. No.: US 2006/0075031 A1
(43) Pub. Date: Apr. 6, 2006

(54) Bounce management

(76) Inventors: Dirk P. Wagner, Schiffweiler (DE); Tim Back, Mannheim (DE); Hermann J. Lueckhoff, Sunnyvale, CA (US); Thomas Schlatterer-Kaiser, Gaiberg (DE)

Correspondence Address: KENYON & KENYON LLP, ONE BROADWAY, NEW YORK, NY, 10004, US

(21) Appl. No.: 10/943,705

(22) Filed: Sep. 17, 2004

(51) Int. Cl. G06F 15/16

(52) U.S. Cl. 709/206

(57) ABSTRACT

The present invention provides a method and system for managing incoming potential bounce messages with user-created rules. Bounces that are not recognized by the SMTP may be identified and follow-up actions for these bounces may be performed. A user can create rules for analyzing an incoming message to determine whether the message is a bounce and select follow-up actions that will be performed if the message is determined to be a bounce. Further, manual verification of certain messages is possible if it is unclear that the message is a bounce. Management of bounces that are recognized by the SMTP is also improved. A user may create rules for determining a cause of delivery failure of formal DSNs and select follow-up actions depending on the cause of delivery failure, as well as other factors. Exemplary messages that may be analyzed include e-mails, SMS text messages and FAXes. Follow-up actions may be performed for both informal and formal DSNs to assist in preventing future bounces and to deliver the message. A follow-up action may include, for example, selecting another e-mail address or telephone number associated with the business partner who was the intended recipient. An integrated, user-friendly approach that is specific to addressing bounced e-mails is provided. For high-mass message scenarios, automated bounce management reduced the processing time needed to analyze a large volume of bounced e-mails, such those associated with a marketing campaign. Easy collection and analysis of bounced messages may also useful for providing feedback to vendors who sell e-mail addresses and/or telephone numbers.

### BACKGROUND

Information and computer technology has allowed for enhanced communication mechanisms such as electronic mail (e-mail), Short Message Service (SMS) text messages, and facsimiles (FAXes). These communications are used to transmit messages from one electronic device to another. For example, e-mail messages may be sent from one personal computer to another personal computer via an information network such as the Internet or the World Wide Web (“WWW”). SMS text messages may be used for text message communication between mobile telephone devices. Facsimiles may be used to transmit images of paper documents from one electronic device to another. These communication mechanisms facilitate communications benefiting business operations.

The Internet Engineering Task Force (IETF) maintains requests for comments (RFCs), which are specifications that are set forth by IETF members to promote standardization of some of the technical features used to provide services via the Internet. Messages may follow the simple mail transfer protocol (SMTP), which is set forth by the IETF. The SMTP protocol is defined by, for example, request for comments (RFC 821). SMTP provides formats for messaging between one computer and another using a mail transfer agent (MTA) or mail server, which is a computer program or software agent. An exemplary MTA is contained in the Microsoft Exchange server.

A problem that arises with communications using electronic devices is that a message may not always arrive at its intended destination. These delivery failures are also referred to as “bounces.” Like other aspects of e-mail communications, SMTP provides guidance on how to address bounced messages. If a bounce is recognized by an MTA, a Delivery Status Notification (DSN) is returned to the sender. A DSN is formatted as a multipurpose internet mail extension (MIME) and provides the delivery status. One format for DSNs specified by the IETF is set forth in RFC 3464. DSNs may include a status, which is a numerical code that is used to describe why the e-mail was not delivered. The DSN status provides information that is sometimes difficult to analyze. Further, the DSN status notification process is inflexible and cannot be modified to fit a user's needs.

Sometimes bounced messages do not have a DSN status because the cause of failure is not included among the causes recognized by the SMTP protocol. For example, an out-of-office notification is a reply message that notifies the recipient that the intended recipient has not read the message. Users may filter these e-mails using programs such as Microsoft outlook. However, these programs provide only basic filtering functionality and are not tailored to handling potential bounce messages.

### BRIEF DESCRIPTION OF THE DRAWINGS

FIG. 1 illustrates the operation performed to create bounce rules for analyzing potential bounces according to one embodiment of the invention.

FIG. 2a illustrates a rule modeler with a bounce profile set to accept conditions according to one embodiment of the invention.

FIG. 2b illustrates a rule modeler with a bounce profile set to accept rules and follow-up actions according to one embodiment of the invention.

FIG. 2c illustrates a category modeler to accept category definitions according to one embodiment of the invention.

FIG. 3 illustrates the processing of an incoming potential bounce message according to one embodiment of the invention.

FIG. 4 depicts processing performed to trigger follow-up actions for manually verified bounces, according to one embodiment of the invention.

FIG. 5 illustrates a bounce management system according to one embodiment of the invention.

FIG. 6 depicts a structure of a bounce manager according to one embodiment of the invention.

### DETAILED DESCRIPTION

The present invention provides a method and system for managing incoming potential bounce messages with user-created rules. Bounces that are not recognized by the SMTP may be identified and follow-up actions for these bounces may be performed. A user can create rules for analyzing an incoming message to determine whether the message is a bounce and select follow-up actions that will be performed if the message is determined to be a bounce. Further, manual verification of certain messages is possible if it is unclear that the message is a bounce. Management of bounces that are recognized by the SMTP is also improved. A user may create rules for determining a cause of delivery failure of formal DSNs and select follow-up actions depending on the cause of delivery failure, as well as other factors. Exemplary messages that may be analyzed include e-mails, SMS text messages and FAXes. Follow-up actions may be performed for both informal and formal DSNs to assist in preventing future bounces and to deliver the message. A follow-up action may include, for example, selecting another e-mail address or telephone number associated with the business partner who was the intended recipient. An integrated, user-friendly approach that is specific to addressing bounced e-mails is provided. For high-mass message scenarios, automated bounce management reduced the processing time needed to analyze a large volume of bounced e-mails, such those associated with a marketing campaign. Easy collection and analysis of bounced messages may also useful for providing feedback to vendors who sell e-mail addresses and/or telephone numbers.

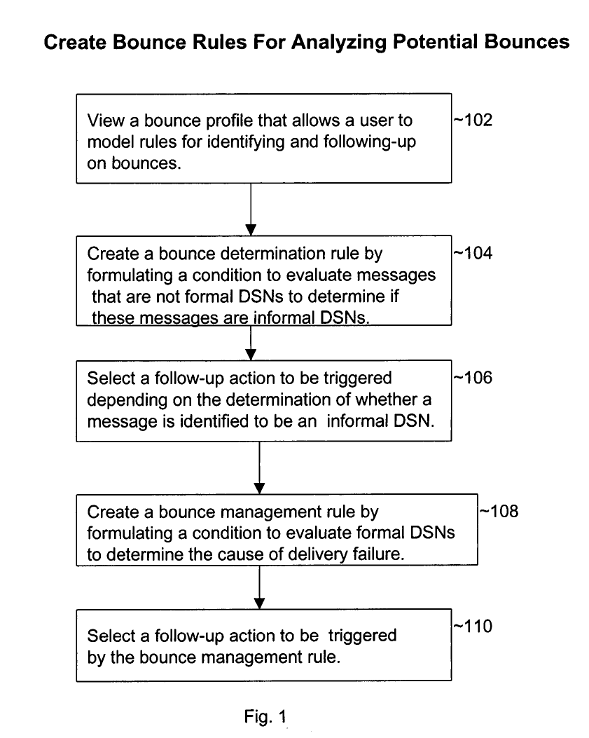

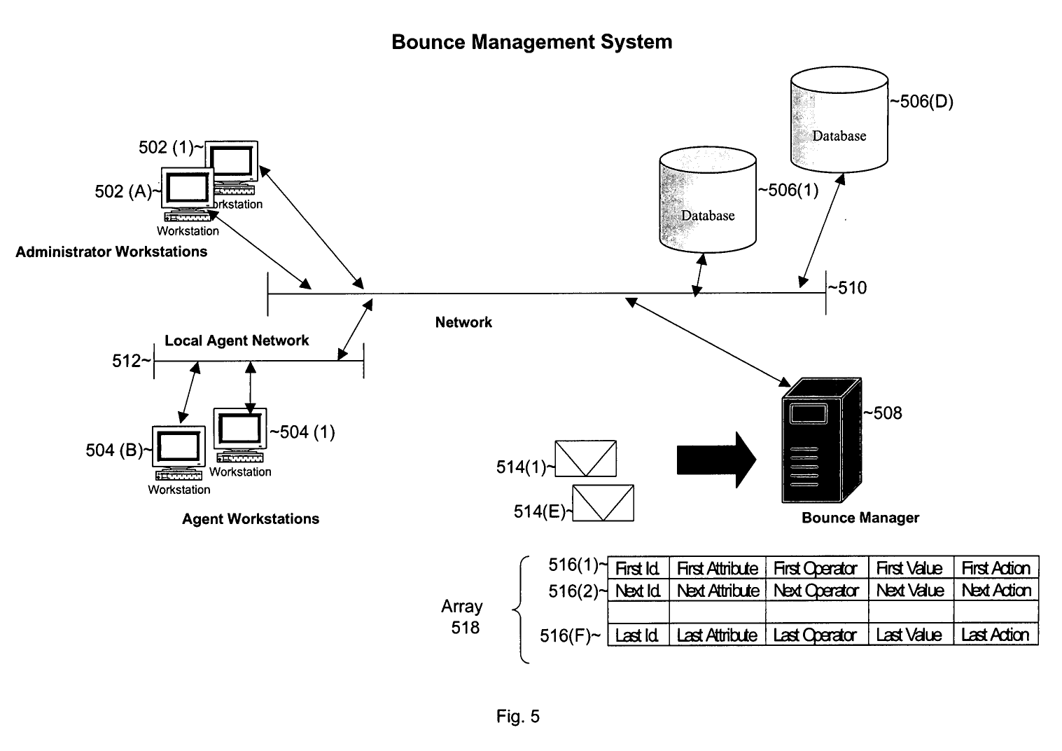

FIG. 1 illustrates the operation performed to create bounce rules for analyzing potential bounces according to one embodiment of the invention. This operation may be performed in any device that provides a user interface including, for example, any one or more of administrator workstations 502(1)-502(A) described with respect to FIG. 5.

In step 102, a bounce profile is provided to a user that allows the user to model rules for identifying and follow-up on bounces. Providing a bounce profile tailored for creating rules for addressing bounces may simplify the process of defining rules for a user. The bounce profile may be implemented using a Context Identifier for bounce message rules. Each rule that is created with the bounce profile may be assigned the Context Identifier “BOUNCE.” During execution of the rules, only those rules with a Context Identifier “BOUNCE” may be triggered, which may minimize the time for executing the rules. The bounce profiler may be used to model rules for both bounce determination and for managing bounces. Bounce determination rules are used to determine whether a message is a bounce. If a message is not a bounce, it can proceed to an inbox for ordinary processing. If a message is a bounce, bounce management processing may be useful to help eliminate future bounces and to reroute the message so that it can be delivered.

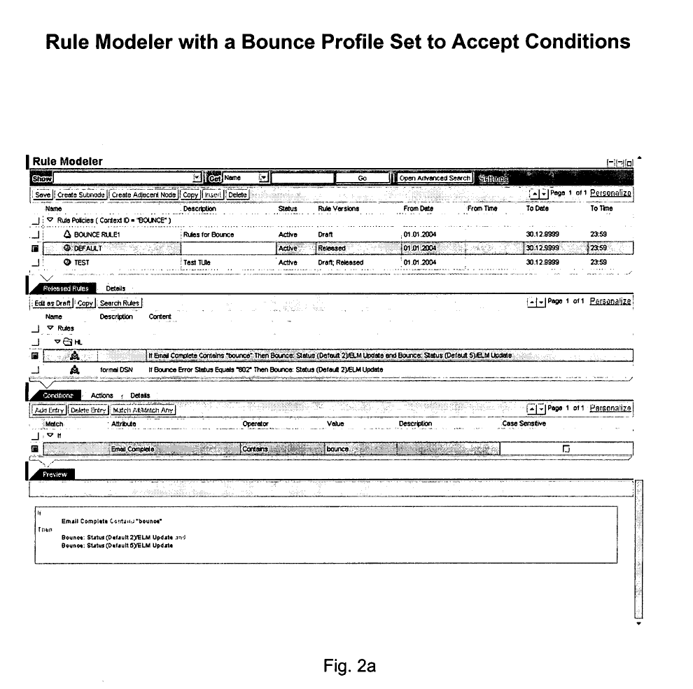

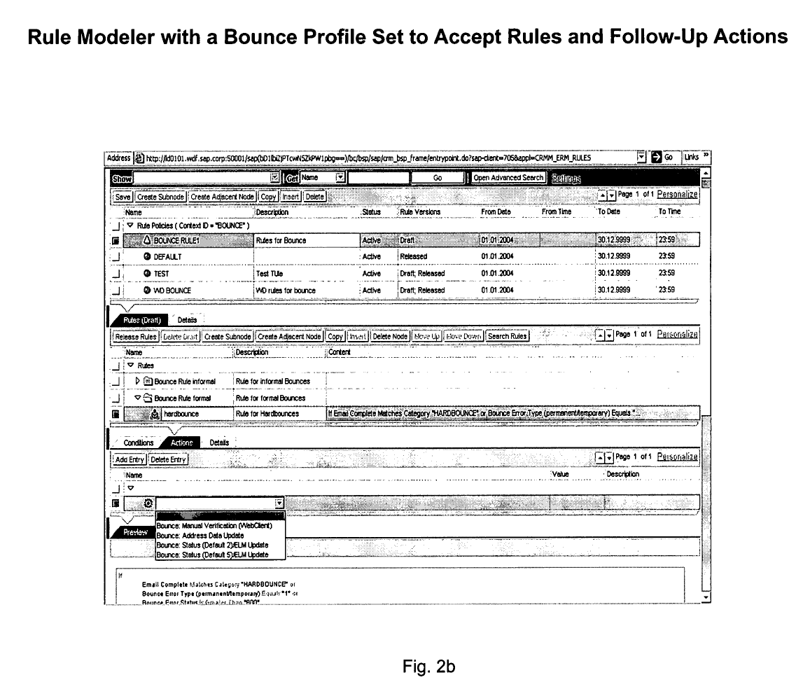

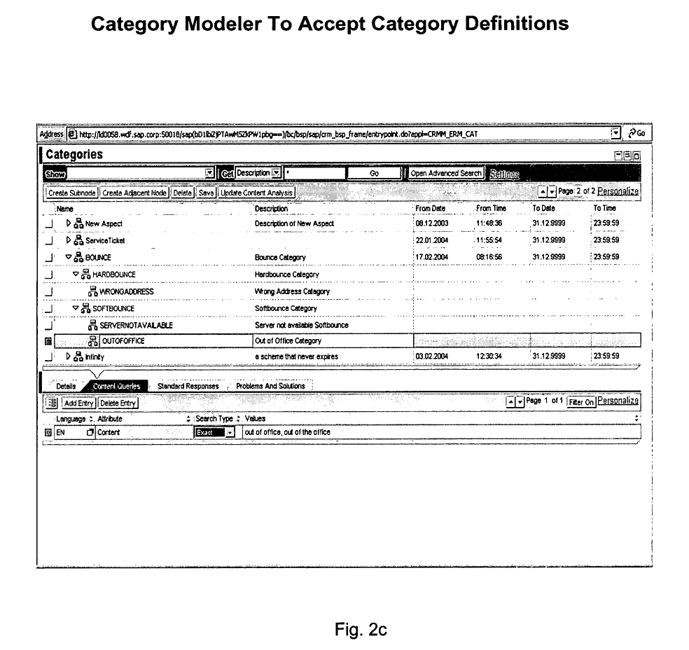

In step 104, bounce determination rules are created by formulating conditions to evaluate messages that are not formal DSNs to determine if these messages are informal DSNs. As illustrated with respect to FIG. 2a, the bounce profile may include a tab that when selected allows a user to select from various attributes. Determining whether a message is a bounce may involve considering fields from the incoming message. Exemplary fields are the sender of the message, the subject of the message, and the body of the message. These fields are attributes of the message. A user may set forth a bounce determination condition by selecting one of these attributes, selecting an operator, and then selecting a value. An operator indicates what operation should be performed. Exemplary operators include contains, contains element, equals, greater than, less than, matches category, does not contain, does not contain element, is not equal, is not greater than, is not less than, and does not match category. These operators may be tailored the particular attribute that has been selected. For example, if the attributed sender of the message is selected, the operators that may be selected may include a subset of the possibly operators such as the subset contains, contains element, matches category, does not contain, does not contain element, and does not match category. The user may also select a value that will be used in the operation. For example, if the user wants to check for out of office messages, the user will select a value that is useful for indicating that the message is an out of office bounce.

A category modeler may be used to create categories that can be used to formulate conditions. A category may be defined by providing a search type and the values to search for. The category contains values that would be located in the search. For example, an out of office category may be created by specifying a search type of “exact” and values of “out of office” and “out of the office.” Values that are exact matches of “out of office” and “out of the office” would be retrieved in this search and are, therefore, within this category. A category may be defined using other search types including fuzzy logic search types. These fuzzy logic search types may indicate that a string located in the search is close to but not exactly the value that was searched for. In the example above, a string “out of town” would be close but not exactly the same as either of the values searched for. Yet another search type is a linguistic search type, which also searches for strings that are not identical to the value that is searched for.

Once a category is defined, a content analysis attribute is selected in the rule modeler and then the category is selected to be the value that is checked. Content analysis attributes include accuracy, all categories, top-scoring category, top-scoring distance, other top-scorers, top-scoring score, and language. The attribute “accuracy,” for example, may be used to indicate how close the retrieved string was to the value that was searched for. A classification result may be generated using as input a list of previous requests for information, calculating an accuracy measure using class-weights associated with the candidate classes present in the input, and comparing the accuracy measure to a predetermined value. In some implementations, the method may also include displaying a class-score indicating a text-mining similarity of a class with the request for information, displaying messages from a candidate classes, and sending a recommendation based on the accuracy measure and the predetermined value comparison. The content analysis attributes may be returned for any of the search types including exact, linguistic, fuzzy logic, or any other search type used.

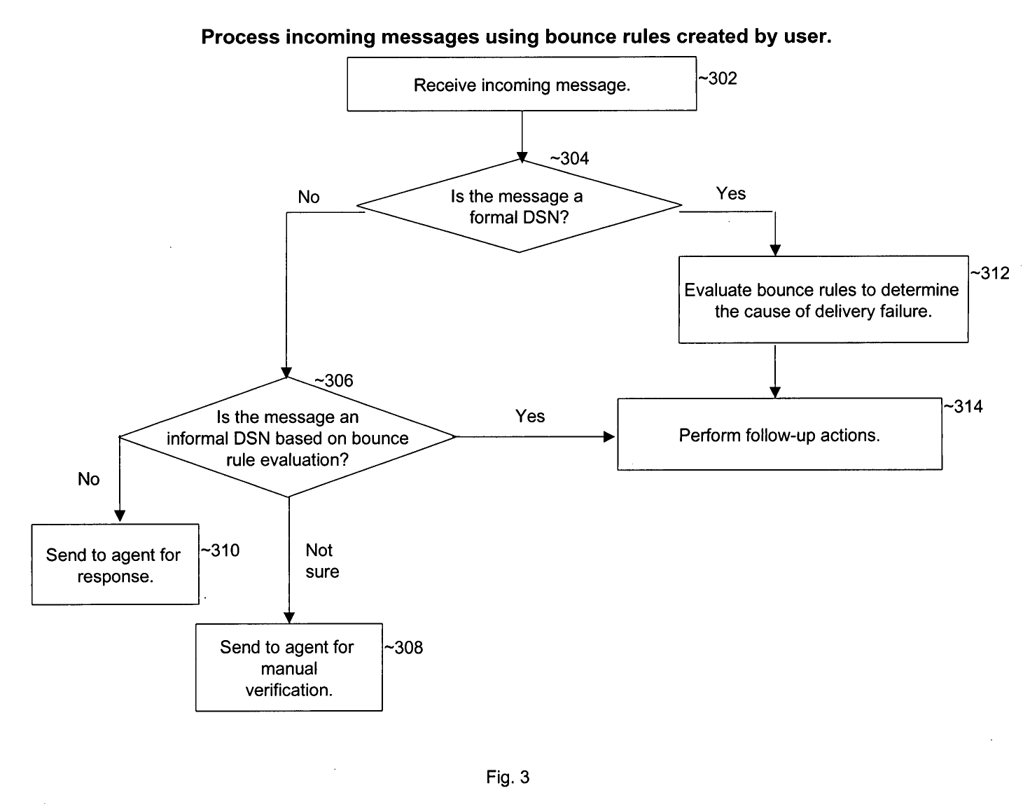

In step 106, a follow-up action is selected. A user may select a follow-up action that may be performed depending on the determination of whether a message is identified to be an informal DSN. For example, a user may create a rule that assigns an uncertain status to a message and may select that as a follow-up action, manual verification should be performed to determine whether the message is an informal DSN. Manual verification will be discussed in more detail with respect to steps 306 and 308 of FIG. 3. If the message is determined to be an informal DSN, a follow-up action may be performed to reduce the number of future bounces or to reroute the message so that it can be delivered. Follow-up actions that provide bounce management will be described in more detail with respect to Step 110.

In step 108, a bounce management rule is created by formulating a condition to evaluate formal DSNs to determine the cause of delivery failure. The condition may be formulated by using attributes, operators, and values, as was described with respect to step 104. Once a message has been identified to be a bounce, other attributes may be considered in formulating rules for management purposes. For example, a status code derived from an error code transmitted by the SMTP protocol might be considered. Also, a “bounce type” may be considered and the communication type of the bounce, e.g., e-mail, SMS text message or FAX. Once the attribute is selected, an appropriate operator and value may then be selected. As was described with respect to step 104, a category modeler may be used to model categories that can then be used as values when a content analysis attribute is selected.

A bounce type may be permanent (or hard) or temporary (or soft). If the cause of delivery failure is such that the message would have no chance of success if it were retransmitted, the bounce is a permanent bounce. If on the other hand, the delivery failure is temporary and the message might have a chance of success if it were retransmitted, the bounce is a temporary bounce because resending could lead to successful contact.

An error code provided by the SMTP protocol may be useful for distinguishing between permanent and temporary bounces. Formal DSNs have error codes of the type x.y.z (enhanced status codes as defined by RFC 1893). If the message has an SMTP status code, the code may be mapped to an internal code to provide greater flexibility in analyzing and following-up on bounced messages. The first digit may provide the type of bounce, for example, whether the bounce is temporary or permanent. For example, SMTP error codes starting with a “5” may tend to be serious bounces whereas error codes in the 400 range may be less serious. A prior definition of hard bounces is bounces that were sent back to the sender undelivered without having been accepted by the recipient's mail server. A prior definition of a soft bounce, on the other hand, is a bounce that is sent back undelivered after it has been accepted by the recipient's mail server. However, this distinction may not be useful. For example, if a mail server is full, retransmission of the message at a later time when the mail server is less full may be result in successful delivery. Mapping SMTP error codes to internal status codes allows for greater flexibility in defining which messages are permanent (or hard) bounces and which messages are temporary (or soft) messages. The internal mapping can be used to categorize permanent bounces as bounce with no chance of success and temporary bounces as bounces for which resending could lead to successful contact. For example, SMTP status codes that are permanent bounces may be mapped to the range of 800-899 and SMTP status codes that are temporary may be mapped to the range of 600-699. The SMTP error code representing that the mail server is full could be mapped in the range of 600-699 properly categorizing the bounce as a temporary bounce that may be resolved by resending the message.

In step 110, a follow-up action may be selected to be triggered by the bounce management rule. The bounce type may be used to determine what follow-up actions should be performed. For example, a user may select to resend a message as a follow-up action if the bounce type is temporary. For permanent bounces, the follow-up action might be not to send any more messages to that recipient to reduce the number of bounces. Instead business partner data might be used to retransmit the message. Business partner data may be stored in a database or in any form in computer-readable storage medium. A business partner may be an organization, a person with an affiliated organization or a person with no affiliated organization. Information stored about a business partner may include various contact addresses and numbers. For example, a main e-mail address may be stored, an e-mail address for a marketing contact, as well as other e-mail addresses and telephone numbers for various other contacts within the organization. If a permanent bounce is received in response to a message sent to a main e-mail address, the main e-mail address for the business partner may be set to “do not use” in the database to avoid future bounces to the intended recipient.

FIG. 2a illustrates a rule modeler with a bounce profile set to accept conditions according to one embodiment of the invention. As illustrated in FIG. 2a, a rule modeler set with a ContextID equal to “BOUNCE,” indicating that the rule modeler is using a bounce profile designed to create rules for bounce management, may be used to set conditions for determining whether an incoming message is a bounce. Attributes may be selected, such as “Email Complete,” which is a string of an entire e-mail. An operator may be selected from a list of possible operators. The user may then enter a value or, if a content analysis attribute has been selected, the user may select from categories that have been predefined, as shown with respect to FIG. 2c.

FIG. 2b illustrates a rule modeler with a bounce profile set to accept rules and follow-up actions according to one embodiment of the invention. As illustrated in FIG. 2b, rules many be drafted and released to manage bounced messages including e-mails, SMS text messages, and FAXes. These draft rules may, for example, trigger performance of follow-up actions based on attributes of these messages, as was described with respect to FIG. 1. Various follow-up actions include, for example, stopping a process, updating marketing data, updating business partner data, and manual verification of the message. Any one or more of these possible follow-up actions may be selected by a user to be assigned to a rule so that it can later be triggered as specified by the rule.

FIG. 2c illustrates a category modeler to accept category definitions according to one embodiment of the invention. Category modeler allows categories to be defined, by example, selecting the content query tab. A content query category will search the content specified for varies values. Various types of searches may be performed and can be selected by selecting the arrow to see choices. For example, categories may be modeled to check for informal DSNs by creating searches for text, such as out of office, that would be included in an informal DSN.

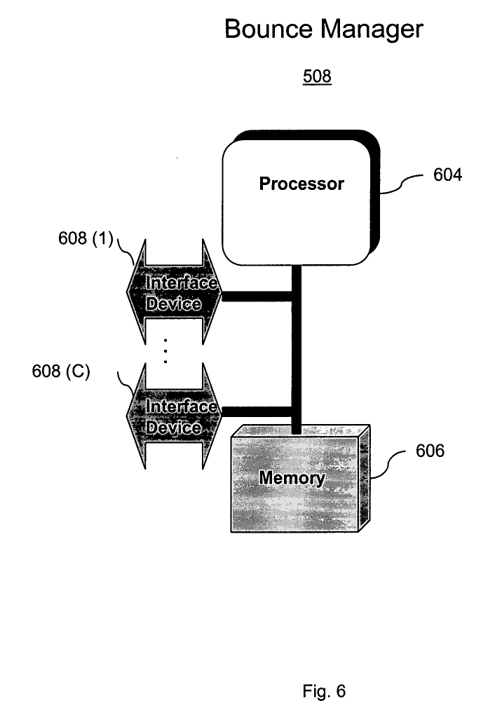

FIG. 3 illustrates the processing of an incoming potential bounce message according to one embodiment of the invention. The operations described in FIG. 3 may be performed by any programmable processor including, for example, bounce manager 508 described with respect to FIGS. 5 and 6.

In step 302, the incoming potential bounce message is received. Initially the message may be parsed and a stored, for example, as an object is created. An incoming potential bounce message may be received from, for example, an SMTP plug-in.

In step 304, a determination is made of whether the message is a formal DSN. If the message has an SMTP error code, the message is a formal DSN. Processing proceeds to step 312 to determine if any follow-up actions should be performed. If in step 304, a determination is made that the message does not have an SMTP error code, then further analysis must be performed to determine if the message is a bounce. Processing proceeds to step 306 to determine if the message is an informal DSN.

In step 306, a determination is made of whether the message is a bounce. Information may retrieved from fields of the message to determine whether the message is a bounce. Information that may be retrieved includes the sender's address of the incoming bounce, the subject field of the incoming bounce, and the body of the incoming bounce.

Pattern matching may be used in comparisons with the information that was retrieved to determine if the message is a bounce. This may be done by comparing any attribute to a value selected by a user using the rule modeler. Additionally, a user may define a category and pattern matching may be implemented using a content analysis service to determine if an informal DSN has been received. Content analysis may be based on a classification method, such as a query-based classification or an example-based classification. Queries used to perform query-based classification may be random search requests with full text and/or attribute searching. Attributed conditions may be formulated and implemented as rules. Example-based classification may be performed by declaring text for which a similar coefficient is determined during parsing. An example of such a category is the “out of office” category. To determine whether a message is an “out of office” informal DSN, the subject field of the incoming bounce message may be parsed and a pattern analysis may be performed to determine whether the subject includes the text “out of office” or “out of the office.” If the subject contains the text “out of the office,” the message is an informal bounce and processing may proceed to step 314.

If the message is not a bounce, no further bounce processing is needed and the call may be routed along with other incoming messages to, for example, an inbox of an agent who will provide a response, as is reflected in step 310. If the message is a bounce, then processing proceeds to step 314.

In one embodiment of the invention, the system may determine that it is uncertain whether a message is a bounce. An uncertain status may be determined using an “accuracy,” which reflects the likelihood that a message is a bounce. An accuracy may be calculated to be a value between 0 and 1 based on formulas set by the user using, for example, fuzzy logic mechanisms available with the category modeler. The user may set, for example, that messages having an accuracy of less than 0.5 have an “uncertain” status, reflecting that it is uncertain whether the message is a bounce and messages having an accuracy of 0.5 or higher can be considered to be bounces. If a message was received that included the text “out of town” and an accuracy of 0.3 was calculated for the result that this message was an “out of town” bounce, the message would have an uncertain status and processing may proceed to step 308 for manual verification. If instead an accuracy of 0.8 was calculated, if for example, the text were “out of my office,” the message would be considered to be a bounce and processing would proceed to step 312. If it is unclear whether a message is a bounce processing may proceed to step 308 so that manual verification may be performed. Use of manual verification for only selected messages significantly reduces workload associated with using manual verification and improves the accuracy of processing informal bounces. This is especially the case when many messages are being processed. However, an alternate embodiment of is possible in which no uncertain status may be recognized and no manual verification is used.

In step 312, bounce rules are evaluated to determine the cause of the delivery failure.

Information may be collected to perform follow-up actions. The information that may be collected includes, for example, a mail error status (if the message is a formal DSN), the original outbound message, the communication type, and the bounce type. The original outbound message is the actual original message that was sent but was not able to be delivered. This is retrieved from contact tracking storage using a message identifier (MIG). The communication type may be used to indicate the type of communication channel that was used to transmit the message. For example, “INT” may be used to indicate that a message was an e-mail message, “PAG” may be used to indicate that a message was an SMS text message, and “FAX” may be used to indicate that a message was a FAX. This information is checked against the rules that were created by the user to determine what follow-up actions should be performed, if any.

In step 314, follow-up actions are triggered to manage bounces. These follow-up actions are triggered based on user-created rules. For example, if a user-created a rule to set e-mail addresses to “do not use” if a bounce is a permanent bounce, a macro may be used to determine from the status whether a bounce is temporary or permanent. If a bounce is a permanent bounce, the e-mail address of the recipient may be set to “do not use.”

In one embodiment of the invention, the bounce management system interfaces with systems that track contacts with customers, for example, to provide customer relationship management during marketing campaigns. Customer relationship management may be performed by analyzing this stored data to identify, for example, customer preferences. Customer interactions may be tracked using, for example, an interaction object that is stored in contact tracking storage. An interaction object may be used to track a name of the contact, the organization, the date of the communication, and the actual text of the message. In addition, a status may be stored with the interaction object. This status may be 0, if contact was achieved, 1, if contact was not possible because communication data was missing, 2, if contact was not possible if communication data was incorrect, 3, if contact was not permitted because the maximum usage of the business partner list was used, 4, if contact was not permitted because there was a block indicator for the business partner, and 5 if contact was not possible because of technical problems. Follow-up actions may include updating this status in the interaction object stored for the original outbound message based on information received in the bounce message returned as a result of the delivery failure.

Checking rules to determine whether a follow-up action should be performed may involve checking a list of rules using “or” function. If any of the rules apply, the corresponding follow-up action is performed. An “and” function may also be used during rule execution. For example, a check may be made using the status code that is mapped to the SMTP status code to see if a message bounced because the recipient's address was not recognized. If a message is bounced because the recipient's address was not recognized, a follow-up action may be performed to forward the bounced e-mail to another contact in the organization. This may involve looking up business partner information of the recipient. In addition to checking the cause of the bounce, a second condition may be to checked to determine whether the e-mail was sent as part of a marketing campaign by, for example, using the subject of the original outbound e-mail. If the second condition is also met, a follow-up action may be to resend the message to a marketing contact retrieved from the business partner database.

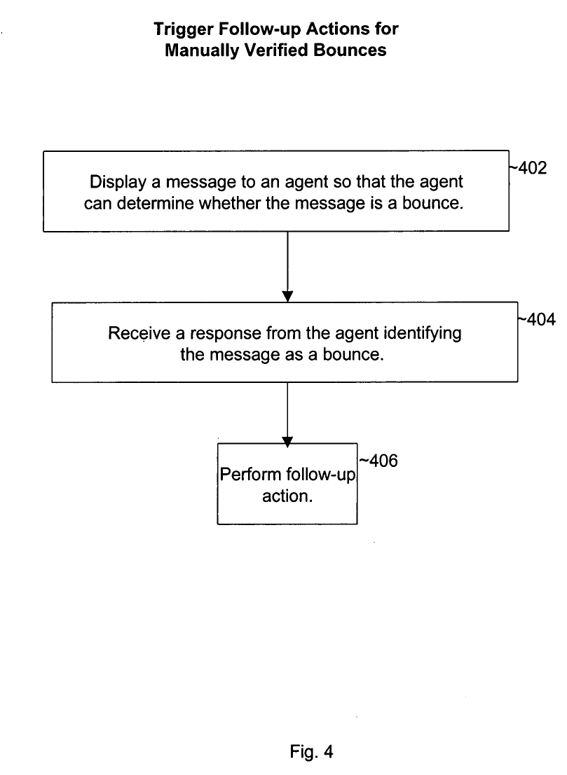

FIG. 4 depicts processing performed to trigger follow-up actions for manually verified bounces, according to one embodiment of the invention. If a message is recognized as a potential bounce, it may be sent to an agent for manual verification. A message that is routed to an agent for manual verification may have a flag set “isbounce” to indicate that the message should receive manual verification to determine if it is a bounce. In step 402, a message is displayed to an agent so that the agent can determine that the message is a bounce. Routing may be used to assign a potential bounce to an agent or a group of agents, such as agents using agent workstations 504(1)-504(B), to perform manual verification.

In step 404, a response is received from the agent indicating that the message is a bounce. An agent may use preview or click on an e-mail message to review the new message. If the message determines that the message is a bounce, the agent can delete the new message using the delete button to identify that the message is a bounce. If the message is not a bounce, the agent may create a work item that will cause the message to be stored and processed along with other incoming messages. No follow-up actions will be triggered as a result.

In step 406 follow-up actions may be performed to manage the manually verified bounce in the same bounces that were identified using automated mechanisms. Follow-up actions are triggered by the response of the agent indicating that a message is a bounce. Processing may proceed as was describe with respect to step 312 of FIG. 3 to perform follow-up actions.

FIG. 5 illustrates a bounce management system according to one embodiment of the invention. Bounce management system comprises administrator workstations 502(1)-502(A), agent workstations 504(1)-504(B), databases 506 (1)-506(D) and bounce manager 508, which are connected via network 510.

Administrator workstations 502(1)-502(A) may be used by administrators to create bounce rules for analyzing potential bounces and define categories that will be used by these rules. Administrator workstation 502 may operate with bounce manager 508 to provide user interfaces for the creation of bounce management rules or may operate as a standalone unit to provide these user interfaces. If administrator workstation operates as a standalone unit, bounce rules and categories may be downloaded later to bounce manager 508. In an alternate embodiment of the invention, the bounce rules and categories may be stored in any one of databases 506(1)-506(D) that may be accessed via bounce manager 508. Agent workstations 504(1)-504(B) receive messages from bounce manager 508 to perform manual verification. Administrator workstations 502(1)-502(A) and agent workstations 504(1)-504(B) may be any programmable processor connected to a machine-readable medium that can provide a user interface such as a computer having a graphical user interface (GUI), a phone, or a personal data assistant. Such devices may comprise an output device that can provide to a user any form of sensory feedback such as voice, auditory or tactile (e.g., liquid crystal display (LCD), cathode ray tube (CRT), or earpiece) and an input device providing any form of input to the computer including acoustic, speech, or tactile input (e.g., keyboard, mouse, trackball, keypad). Agent workstations 504(1)-504(A) may be connected via a local network, such as a LAN, so that messages requiring manual verification can be sent to any one of agent workstations 504(1)-504(B).

Databases 506(1)-506(D) are any data stored on any machine-readable medium including any computer program product, apparatus and/or device (e.g., a random access memory (RAM), read only memory (ROM), magnetic disk, optical disk, programmable logic device (PLD), tape or any combination of these devices). Databases may be stored according to any file format that may be used to organize data. Rules created by administrators may be downloaded from administrator workstations 502(1)-502(A) via network 510 to any one or more of databases 506(1)-506(D). Additionally, business partner information may be stored in any one of databases 506(1)-506(D). Further, data relating to the outbound messages including interaction objects and contact tracking storage may be stored on any one of databases 506(1)-506(D).

Bounce manager 508 may be used to process an incoming potential bounce message and to manage bounced messages. Messages 514(1)-514(E) are received by bounce manager 508. Bounce manager 508 evaluates messages by accessing an array 518 that includes rules 516(1)-516(F). Bounce manager 508 compares an incoming message to each of the rule conditions to determine which rules apply. The comparison may be used for both bounce determination and bounce management. Rule 516 may comprises an identifier, express attribute identifier or attribute, operator and value. Bounce manager may be accessed via any connection or network, e.g., via the Internet.

FIG. 6 depicts a structure of a bounce manager 508 according to one embodiment of the invention. Bounce manager 508 includes processor 604, memory 606, and interface devices 608 (1)-608 (C). Processor 604 is connected to memory 604. Processor 604 is also connected to interface devices 608 (1)-608(C). These connections are direct or via other internal electronic circuitry or components.

Processor 604 may be any programmable processor that executes instructions residing in memory 606 to receive and send data via interface devices 608(1)-608(C). The instructions may perform the operations of the bounce manager 508. Processor 604 may be any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 604 is an Intel microprocessor.

Memory 606 is a machine-readable medium that stores data that is processed by processor 1304. Memory 606 may be any device that stores digital data including any computer program product, apparatus and/or device (e.g., a random access memory (RAM), read only memory (ROM), magnetic disc, optical disc, programmable logic device (PLD), tape, or any combination of these devices). This may include external machine-readable mediums that are connected to processor 604 via one or more interface devices 608(1)-608 (A).

Interface devices 608 (1)-608 (A) are interfaces that receive and/or send digital data to and from an external device. Interface 608 may be any point of access to an external device where digital data is received or sent, including a port, buffer, queue, subsets thereof, or any other interface to an external device.

Various implementations of the systems and techniques described here can be realized in any processing systems and/or digital electronic circuitry, integrated circuitry, specially designed ASICs (application specific integrated circuits), computer hardware, firmware, software, and/or combinations thereof. There various implementations can include computer code.

A number of embodiments of the invention have been described. Nevertheless, it will be understood that various modifications may be made without departing from the spirit and scope of the invention.

What is claimed is:

1. A method for evaluating an incoming message using bounce rules created by a user comprising:
upon receipt of a first message, determining from message contents whether said message is an informal status notification; the determining comprising processing bounce rules, wherein each bounce rule comprises an attribute, an operator, and a value; and
performing a first follow-up action triggered by processing said bounce rules, wherein said first follow-up action is performed to avoid future bounces or to resend said first message.

2. The method of claim 1, further comprising:
upon receipt of a second message that is a formal delivery status notification, performing a second follow-up action to avoid future bounces or to resend said second message based on a determination of a cause of delivery failure of said second message.

3. The method of claim 1, wherein said processing bounce rules triggers transmission of said first message to an agent for manual verification.

4. The method of claim 2, wherein said second follow-up action is to resend said second message because said bounce is a temporary type bounce.

5. The method of claim 2, wherein said first follow-up action or said second follow-up action is to update intended recipient contact information stored to do not use status.

6. The method of claim 2, wherein said second follow-up action is to resend said second message using alternate contact information retrieved from business partner data.

7. The method of claim 2, wherein said second follow-up action is to resend said second message although a recipient's mail server did not accept said second message.

8. The method of claim 2, wherein said second follow-up action is to update a status of an original outgoing message that was not delivered resulting in said second message using information received in said second message.

9. A computer readable medium storing thereon program instructions that, when executed, cause an executing device to:
upon receipt of a first message, determine from message contents whether said message is an informal status notification by processing bounce rules, wherein each bounce rule comprises an attribute, an operator, and a value; and
perform a first follow-up action triggered by processing said bounce rules, wherein said first follow-up action is performed to avoid future bounces or to resend said first message.

10. The computer readable medium of claim 9, storing thereon program instructions that, when executed, further cause the executing device to:
upon receipt of a second message that is a formal delivery status notification, perform a second follow-up action to avoid future bounces or to resend said second message based on a determination of a cause of delivery failure of said second message.

11. The computer readable medium of claim 9, wherein said processing bounce rules triggers transmission of said first message to an agent for manual verification.

12. The computer readable medium of claim 10, wherein said second follow-up action is to resend said second message because said bounce is a temporary type bounce.

13. The computer readable medium of claim 10, wherein said first follow-up action or said second follow-up action is to update intended recipient contact information stored to do not use status.

14. The computer readable medium of claim 10, wherein said second follow-up action is to resend said second message using alternate contact information retrieved from business partner data.

15. The computer readable medium of claim 10, wherein said second follow-up action is to resend said second message although a recipient's mail server did not accept said second message.

16. The computer readable medium of claim 10, wherein said second follow-up action is to update a status of an original outgoing message that was not delivered resulting in said second message using information received in said second message.

17. A system for identifying and managing bounces comprising:
a processor;
a memory coupled to said processor;
a bounce manager residing in said first memory and executed by said first processor, said bounce manager comprising:
bounce determination module for identifying informal delivery status notifications based on rules created by a user and triggering follow-up actions based on said rules; and
bounce management module for identifying a cause of failure for formal delivery status notifications based said user-created rules and triggering follow-up actions based on said rules.

18. The system of claim 17, further comprising:
a database for storing business partner data to be used for performance of said follow-up actions coupled to said processor.

19. The system of claim 17, further comprising:
an administrator workstation coupled to said processor for creating rules to be used to manage bounces.

20. The system of claim 19, further comprising:
an agent workstation coupled to said processor for manually verifying that messages are informal delivery status notifications.
